(19) United States
(12) Patent Application Publication
(10) Pub. No.: US 2015/0158553 A1
(43) Pub. Date: Jun. 11, 2015

(54) BICYCLE CABLE FASTENER

(71) Applicant: WAYNE-IAN MOORE, CHANGHUA COUNTY (TW)

(72) Inventor: WAYNE-IAN MOORE, CHANGHUA COUNTY (TW)

(21) Appl. No.: 14/100,021

(22) Filed: Dec. 9, 2013

(51) Int. Cl. B62M 25/02; B62J 11/00

(52) U.S. Cl. CPC B62M 25/02; B62J 11/00

(57) ABSTRACT

A bicycle cable fastener, which is configured to adjust a cable, includes an outer shell, a pressing assembly and a plurality of balls. The outer shell has an assembling hole defined therethrough and an oblique guide face annularly defined at the assembling hole. The pressing assembly has a base member and a cylinder. The base member is assembled with one end of the cylinder. The other end of the cylinder passes into the outer shell and is axially movable relative to outer shell. The cylinder has a through hole defined therein. Specifically, a plurality of cavities is defined around an outer periphery of the cylinder opposite to the base member. The balls are respectively disposed in the cavities of the cylinder and biased inwardly by the oblique guide face of the outer shell so as to tighten the cable.

### BACKGROUND OF THE INVENTION

1. Field of the Invention

The present invention relates to a fastener and more particularly to a bicycle cable fastener.

2. Description of Related. Art

Bicycle cables are provided to control bicycle parts as derailleur and more particularly to bicycle brakes. Manually actuated bicycle brakes and derailleur systems are actuated by operating brake or derailleur levers that are located on the handlebars and connected to front and rear brakes and derailleur by a cable. Typically, the cable includes a control cable displaceable within an outer housing. To adjust the control cable, an adjustment device is located at one or both ends of the outer housing.

A conventional cable adjustment device for a cable has a control cable disposed within a cable housing for a bicycle component. The adjustment device includes a guide element axially and rotationally fixed to the bicycle component and has a control cable bore therethrough. An adjustment member is rotationally fixed and axially disposed in the guide element. The adjustment member has an abutment for engaging the cable housing. The adjustment device further includes an actuation element. The adjustment member is threaded and coupled relative to the actuation element for converting the rotational movement of the actuation element into the axial movement of the adjustment member.

As described above, the conventional cable adjustment device is operated by means of screwing to adjust the tension of the cable. However, the threads of the cable adjustment device will be abraded for a long time usage; therefore, the bicycle brakes would be failure.

The present invention has arisen to mitigate and/or obviate the disadvantages of the conventional cable adjustment device.

### SUMMARY OF THE INVENTION

The main objective of the present invention is to provide an improved bicycle cable fastener.

To achieve the objective, a bicycle cable fastener, which is configured to adjust a cable, the bicycle cable fastener comprises an outer shell, a pressing assembly and a plurality of balls. The outer shell has an assembling hole defined therethrough and an oblique guide face annularly defined at an inner periphery of the assembling hole at one end and gradually sloping inwardly. The pressing assembly has a base member, a cylinder and an elastic member. The base member is assembled with one end of the cylinder and has a lock hole defined therethrough. The other end of the cylinder passes into the outer shell and is axially movable relative to outer shell. The cylinder has a through hole defined therein and in communication with the assembling hole of the outer shell and the lock hole of the base member.

Specifically, a plurality of cavities is defined around an outer periphery of the cylinder opposite to the base member and in communication with the through hole of the cylinder. The elastic member is mounted around the cylinder. The balls are respectively disposed in the cavities of the cylinder and biased inwardly by the oblique guide face of the outer shell so as to tighten the cable, wherein the elastic member is disposed between the balls and the base member.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bicycle cable fastener in accordance with the present invention;

FIG. 2 is an exploded perspective view of the bicycle cable fastener of FIG. 1;

FIG. 3 is a cross-sectional view of the bicycle cable fastener along line of FIG. 1;

FIG. 4 is a cross-sectional view of the bicycle cable fastener along line IV-IV of FIG. 3;

FIG. 5 illustrates the bicycle cable fastener of FIG. 1 is assembled to a brake device;

FIG. 6 illustrates a cable passing through the bicycle cable fastener of FIG. 3;

FIG. 7 is a cross-sectional view of the bicycle cable fastener along line VII-VII of FIG. 6;

FIG. 8 illustrates that the bicycle cable fastener is mounted to a brake lever; and

FIG. 9 illustrates that the bicycle cable fastener is mounted to a rear derailleur.

### DETAILED DESCRIPTION OF THE INVENTION

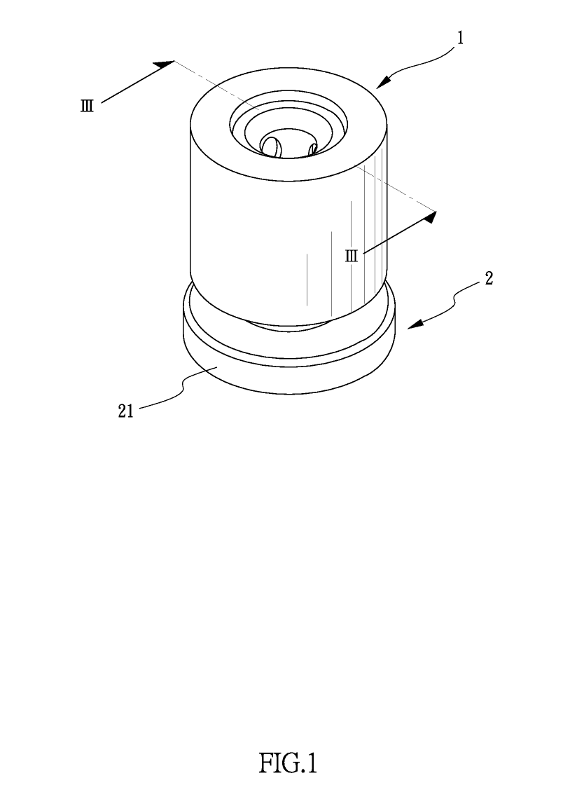

Referring to FIGS. 1-5, a bicycle cable fastener, that is configured to adjust bicycle cables such as brake cables or derailleur cables. In a preferred embodiment, the bicycle cable fastener is attached to a brake device 10, which comprise an outer shell 1 and a pressing assembly 2.

The outer shell 1 having an upper end 11, a lower end 12 and an assembling hole 13 defined through the outer shell 1 from the upper end 11 to the lower end 12. The outer shell 1 has an oblique guide face 131 annularly defined at one end of the assembling hole 13. The oblique guide face 131 gradually slopes toward the upper end 11 of the outer shell 1, so that a diameter of the assembling hole 13 is reduced from the lower end 12 to the upper end 11 of the outer shell 1.

The pressing assembly 2 has a base member 21, a cylinder 22 and an elastic member 23. The base member 21 is assembled with one end of the cylinder 22. The base member 21 has a lock hole 211 defined therethrough. The other end of the cylinder 22 passes into the outer shell 1 through the lower end 12 and the cylinder 22 is axially moved relative to outer shell 1. The cylinder 22 has a through hole 221 defined therein, wherein the trough hole 221 of the cylinder 22 is coaxially arranged and in communication with the assembling hole 13 of the outer shell 1 and the lock hole 211 of the base member 21. The cylinder 22 has a plurality of cavities 222 defined around an outer periphery thereof opposite to the base member 21 and in communication with the through hole 221 of the cylinder 22. A plurality of balls 3 is respectively disposed in the cavities 222 of the cylinder 22. When the cylinder 22 moves relative to the outer shell 1, each of the balls 33 is biased by the oblique guide face 131 of the outer shell 1 so that each of the balls 3 is moved within the respective cavity 222. Furthermore, the elastic member 23 is mounted around the cylinder 22 and located between the balls 3 and the base member 21.

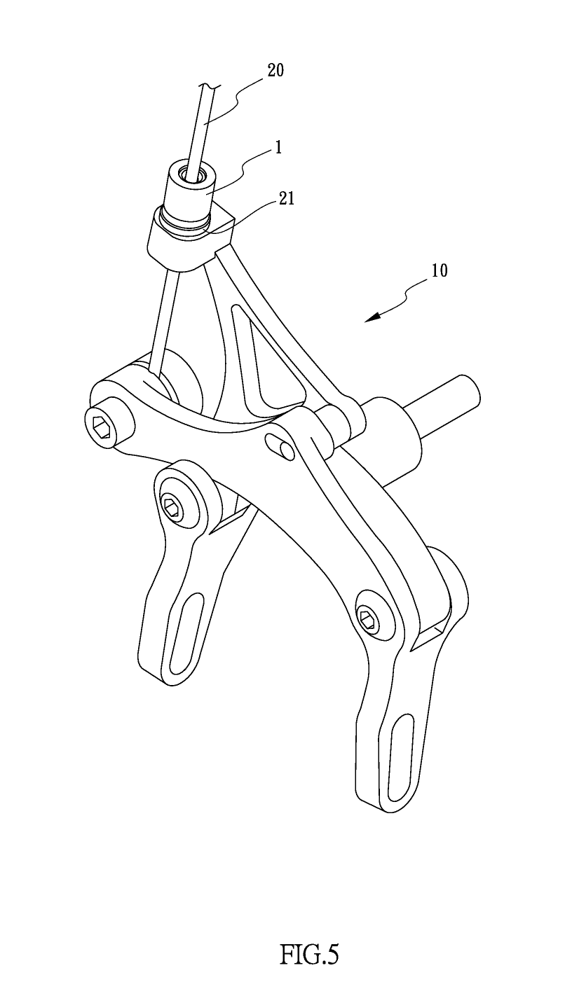

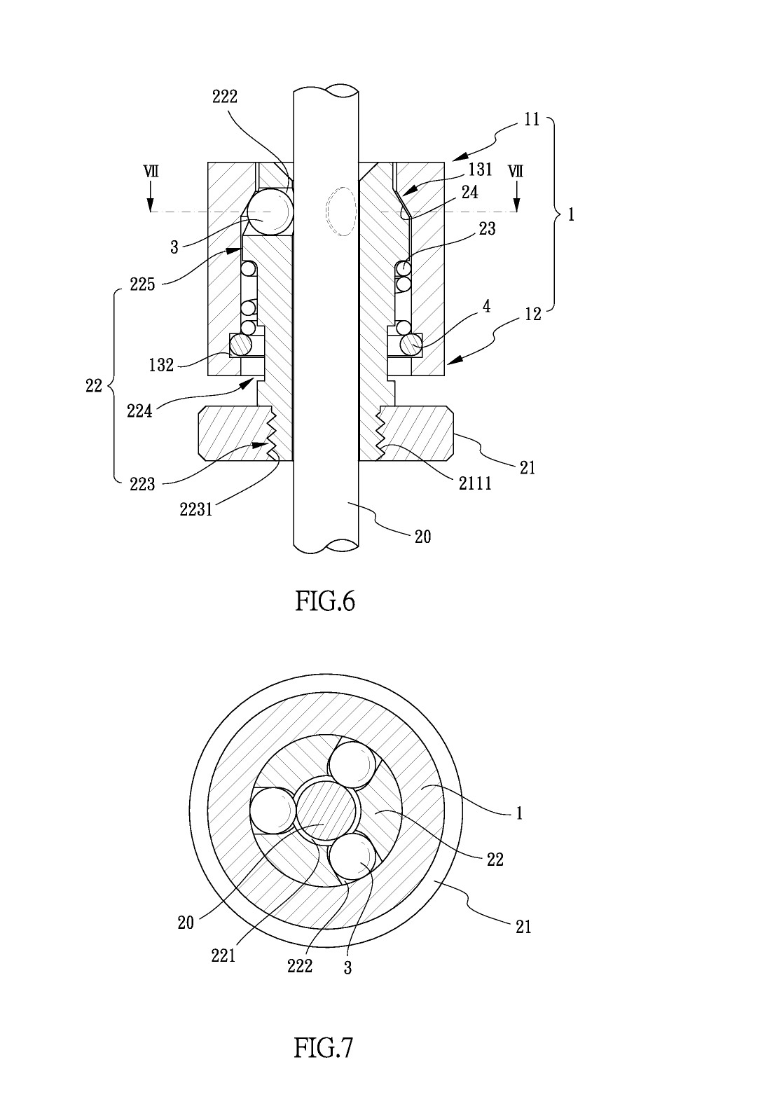

As shown in FIG. 5 and referring to FIGS. 6-7, the bicycle cable fastener is attached to the brake device 10 and mounted around a cable 20. When the pressing assembly 2 is located in a release position relative to the outer shell 1, the balls 3 in the cavities 222 of the cylinder 22 are not biased by the oblique guide face 131 of the outer shell 1, so that the tension of the cable 20 could be adjusted. In contrast, when the pressing assembly 2 is located in a tighten position relative to the outer shell 1, the balls 3 are biased inwardly by the oblique guide face 131 of the outer shell 1 so as to tighten the cable 20. In a preferred embodiment of the present invention, the bicycle cable fastener has three balls 3 disposed in the cavities 222 of the cylinder 22. Therefore, the cable 20 is tightened by the three balls 3 so as to fix the cable 20 and prevent the cable 20 from being sliding. Under this arrangement, the tension of the cable 20 could be quickly and simply adjusted by the bicycle cable fastener.

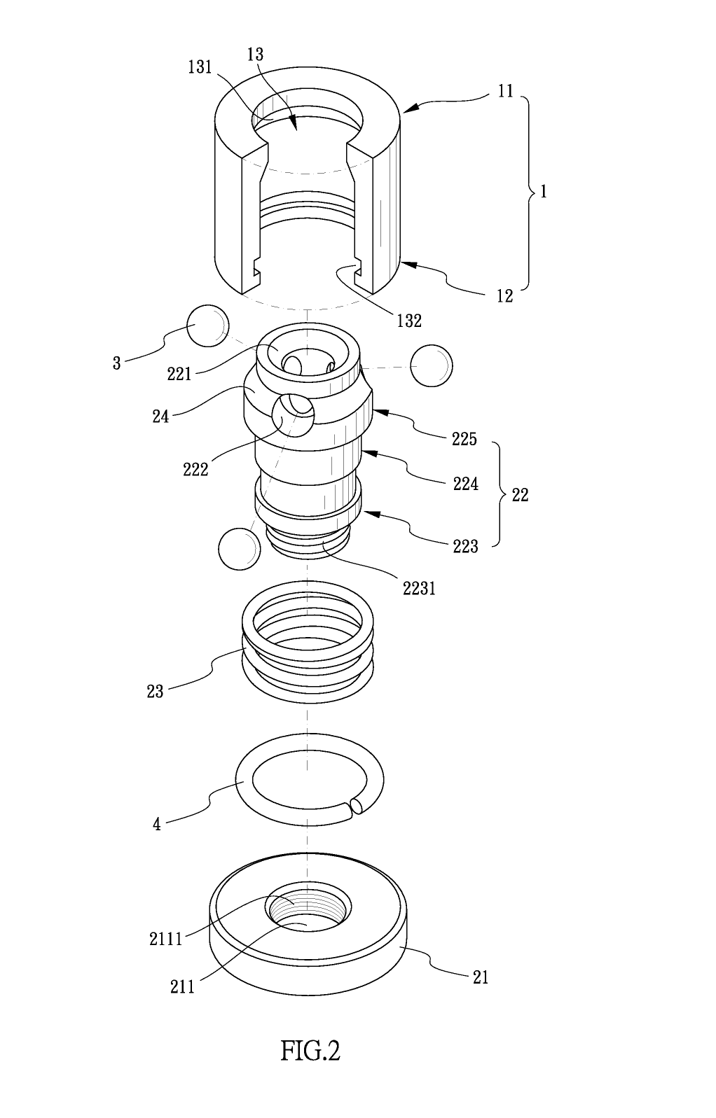

Referring to FIG. 2, the base member 21 is assembled with one end of the cylinder 22 by means of screwing, which is not limited by the present invention. The cylinder 22 has a connection portion 223, a convex portion 225 and a shank 224 disposed in between the connection portion 223 and the convex portion 225. The cavities 222 are spaced a distance apart in the convex portion 225 of the cylinder 22. The connection portion 223 of the cylinder 22 has an external thread 2231 defined at an outer periphery of the connection portion 223. The base member 21 has an internal thread 2111 defined at an inner periphery of the lock hole 211 which corresponds to the external thread 2231 of the connection portion 223. Therefore, the connection portion 223 of the cylinder 22 is screwed in the lock hole 211 of the base member 21.

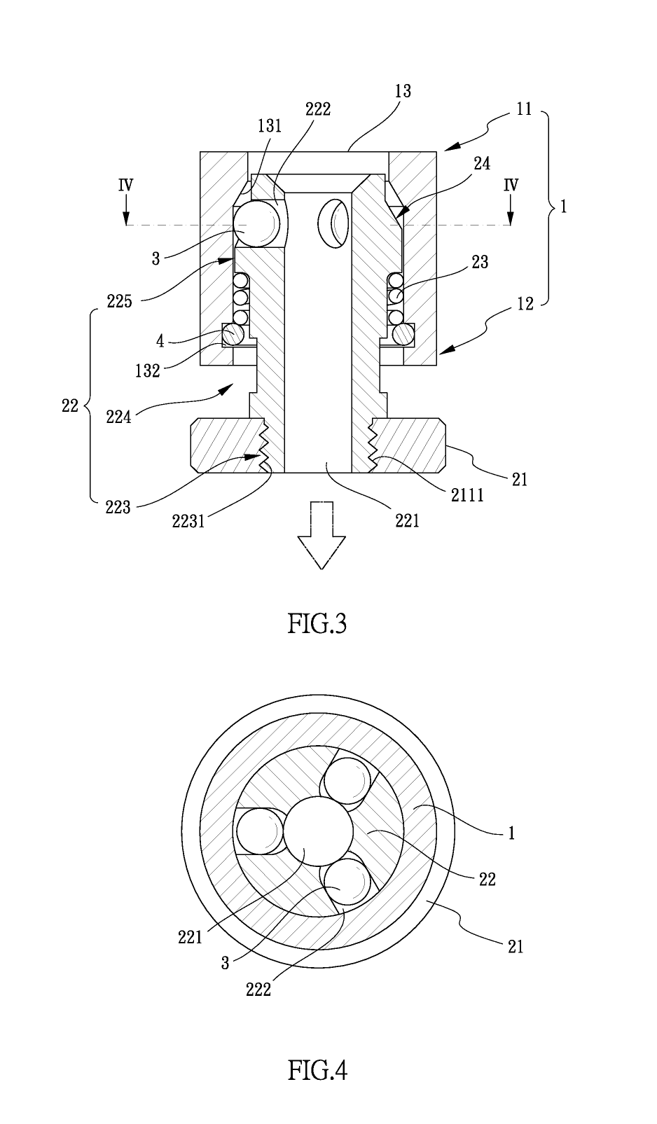

Referring to FIGS. 3-4, the convex portion 225 and the shank 224 are disposed in the assembling hole 13 of the outer shell 1. The convex portion 225 of the cylinder 22 has an inclined face 24 annularly defined at an outer periphery thereof and corresponding to the oblique guide face 131 of the outer shell 1. Therefore, the oblique guide face 131 of the outer shell 1 could abut against the balls 3 smoothly. Furthermore, a C-ring 4 is mounted around the outer periphery of the cylinder 22. The C-ring 4 is disposed between the elastic member 23 and the base member 21. An annular groove 132 is defined in the inner periphery of the assembling hole 13. The C-ring 4 is positioned in the annular groove 132. Therefore, the elastic member 23 is sandwiched in between the convex portion 225 of the cylinder 22 and the C-ring 4 so as to prevent the elastic member 23 from being detached from the outer shell 1.

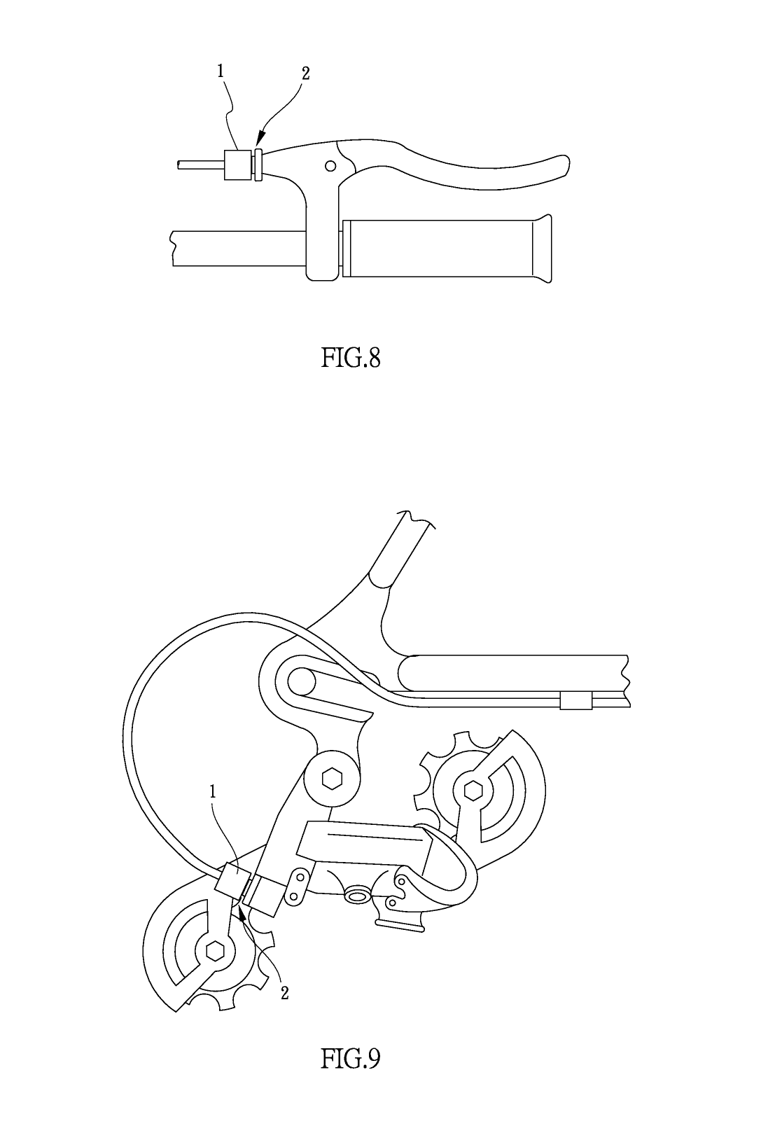

As described above, the bicycle cable fastener could be attached to bicycle cables such as brake cables or derailleur cables. Referring to FIG. 8, the bicycle cable fastener is assembled on a brake lever; and referring to FIG. 9, the bicycle cable fastener is assembled on a rear derailleur.

It is to be understood that the disclosed embodiments are illustrative in nature and the invention is not to be limited to any one or more embodiments except as set forth in the following claims.

What is claimed is:

1. A bicycle cable fastener, which is configured to adjust a cable, the bicycle cable fastener comprising:
an outer shell having an assembling hole defined therethrough and an oblique guide face annularly defined at one end of the assembling hole 13 and gradually sloping inwardly;
a pressing assembly 2 having a base member 21, a cylinder 22 and an elastic member 23, the base member 21 assembled with one end of the cylinder 22 and having a lock hole 211 defined therethrough, the other end of the cylinder 22 passing into the outer shell 1 and being axially movable relative to outer shell 1, the cylinder 22 having a through hole 221 defined therein and in communication with the assembling hole 13 of the outer shell 1 and the lock hole 211 of the base member 21, and a plurality of cavities 222 defined around an outer periphery of the cylinder 22 opposite to the base member 21 and in communication with the through hole 221 of the cylinder 22, the elastic member 23 mounted around the cylinder 22; and
a plurality of balls 3 respectively disposed in the cavities 222 of the cylinder 22 and biased inwardly by the oblique guide face 131 of the outer shell 1 so as to tighten the cable 20, wherein the elastic member 23 is disposed between the balls 3 and the base member 21.

2. The bicycle cable fastener as claimed in claim 1, wherein the cylinder 22 has a connection portion 223 and a shank 224 connected to the connection portion 223; the connection portion 223 of the cylinder 22 has an external thread 2231 defined at an outer periphery thereof and the base member 21 has an internal thread 2111 defined at an inner periphery of the lock hole 211 and corresponding to the external thread 2231 of the connection portion 223.

3. The bicycle cable fastener as claimed in claim 2, wherein the shank 224 of the cylinder 22 is disposed in the assembling hole 13 of the outer shell 1; the cylinder 22 has an inclined face 24 annularly defined at an outer periphery thereof and corresponding to the oblique guide face 131 of the outer shell 1.

4. The bicycle cable fastener as claimed in claim 1, further comprising a C-ring 4 mounted around the outer periphery of the cylinder 22 and an annular groove 132 defined in the inner periphery of the assembling hole 13; the C-ring 4 is disposed between the elastic member 23 and the base member 21 and positioned in the annular groove 132.

5. The bicycle cable fastener as claimed in claim 4, wherein the cylinder 22 has a convex portion 225 defined at one end thereof opposite to the connection end 223; the cavities 222 are spaced a distance apart in the convex portion 225 of the cylinder 22; and the elastic member 23 is sandwiched in between the convex portion 225 of the cylinder 22 and the C-ring 4.
